(19) United States
(12) Patent Application Publication
(10) Pub. No.: US 2025/0232486 A1
(43) Pub. Date: Jul. 17, 2025

(54) SYSTEM, METHOD, PROGRAM, USER TERMINAL, AND SERVER FOR DISPLAYING OBJECT OF USER IN VIRTUAL SPACE

(71) Applicant: CYGAMES, INC., Tokyo (JP)

(72) Inventor: Shuichi Kurabayashi, Tokyo (JP)

(73) Assignee: CYGAMES, INC., Tokyo (JP)

(21) Appl. No.: 19/098,552

(22) Filed: Apr. 2, 2025

Related U.S. Application Data
(63) Continuation of application No. PCT/JP2023/037385, filed on Oct. 16, 2023.

(30) Foreign Application Priority Data
Oct. 18, 2022 (JP) 2022-166988

(51) Int. Cl. G06T 11/00; G06F 3/01

(52) U.S. Cl. CPC G06T 11/00; G06F 3/011

(57) ABSTRACT

One or more embodiments of the invention is a system for displaying an object of a user in a virtual space and includes: a distance score storage unit that stores a distance score indicating the relationship from one user to another user; and a control unit that determines a model of an object of a display-target user on the basis of a distance score indicating the relationship from the display-target user to a user of a user terminal, the distance score being stored in the distance score storage unit, and performs control so as to display the object of the display-target user on the user terminal on the basis of the determined model of the object.

### TECHNICAL FIELD

The present invention relates to a system, a method, a program, a user terminal, and a server for displaying an object of a user in a virtual space.

### BACKGROUND ART

In recent years, metaverses have attracted attention. A metaverse is a virtual space on the Internet, and, in the virtual space, a user can move around or communicate with another user via an avatar that is an alter ego of the user. For example, Patent Literature 1 discloses a system capable of customizing clothes worn by an avatar in a virtual space.

### CITATION LIST

### Patent Literature

[Patent Literature 1] Japanese Translation of PCT International Application, Publication No. 2019-536131
[Non-Patent Literature 1] Sihem Amer Yahia, Michael Benedikt, Laks V. S. Lakshmanan, and Julia Stoyanovich. 2008. Efficient network aware search in collaborative tagging sites. Proc. VLDB Endow. 1, 1 (August 2008), 710-721. DOI: https://doi.org/10.14778/1453856. 1453934
[Non-Patent Literature 2] Norases Vesdapunt and Hector Garcia-Molina. 2016. Updating an Existing Social Graph Snapshot via a Limited API. In Proceedings of the 25th ACM International on Conference on Information and Knowledge Management (CIKM '16). Association for Computing Machinery, New York, NY, USA, 1693-1702. DOI: https://doi.org/10. 1145/2983323.2983703
[Non-Patent Literature 3] Han Hee Song, Tae Won Cho, Vacha Dave, Yin Zhang, and Lili Qiu. 2009. Scalable proximity estimation and link prediction in online social networks. In Proceedings of the 9th ACM SIGCOMM conference on Internet measurement (IMC '09). Association for Computing Machinery, New York, NY, USA, 322-335. DOI: https://doi.org/10.1145/1644893. 1644932

### SUMMARY OF INVENTION

### Technical Problem

The inventors of the present invention anticipate that implementation allowing control of appearance according to the social relationship between oneself and another person would be required when a virtual space, such as a metaverse, functions as a society in the future. The present invention has been made in order to solve the problem, and an object thereof is to provide a system etc. capable of performing control of appearance according to the relationship between users in a virtual space such as a metaverse.

### Solution to Problem

[1] According to one embodiment, the present invention provides a system for displaying an object of a user in a virtual space, the system including:
a distance score storage unit that stores a distance score indicating the relationship from one user to another user; and
a control unit that determines a model of an object of a display-target user on the basis of a distance score indicating the relationship from the display-target user to a user of a user terminal, the distance score being stored in the distance score storage unit, and performs control so as to display the object of the display-target user on the user terminal on the basis of the determined model of the object.

[2] According to one embodiment, the present invention provides a system according to [1], when the display-target user is a personal-account user, the object of the display-target user is a character, and the control unit determines a model of the character corresponding to the distance score indicating the relationship from the display-target user to the user of the user terminal and performs control so as to display the character of the display-target user on the basis of the determined model of the character.

[3] According to one embodiment, the present invention provides a system according to [1] or [2], when the display-target user is a non-personal-account user, the object of the display-target user is an environment, and the control unit determines a model of the environment corresponding to the distance score indicating the relationship from the display-target user to the user of the user terminal and performs control so as to display the environment of the display-target user on the basis of the determined model of the environment.

[4] According to one embodiment, the present invention provides a system according to one of [1] to [3], further including an object model storage unit that stores, for each user, multiple stages of models of an object corresponding to distance scores indicating the relationships from the user to other users,
wherein the control unit selects, from among the models of the object stored in the object model storage unit, one model of the object of the display-target user on the basis of the distance score indicating the relationship from the display-target user to the user of the user terminal, the distance score being stored in the distance score storage unit, and performs control so as to display the object of the display-target user on the user terminal on the basis of the selected model of the object.

[5] According to one embodiment, the present invention provides a system according to [4],
wherein the object model storage unit stores, for each personal-account user, multiple stages of models of a character corresponding to distance scores indicating the relationships from the user to other users, and
a model of the character corresponding to the smallest distance score is a model of the character for family or for best friends.

[6] According to one embodiment, the present invention provides a system according to one of [1] to [5], further including a distance score calculation unit that calculates a distance score indicating the relationship from one user to another user,
wherein the distance score calculation unit calculates a distance score indicating the relationship from one user to another user on the basis of a weight for said another user set by said one user.

[7] According to one embodiment, the present invention provides a system according to [6], wherein the distance score calculation unit calculates a distance score indicating the relationship from one user to another user, further on the basis of the number of links between nodes of said one user and said another user, the nodes indicating individual users in a social graph.

[8] According to one embodiment, the present invention provides a the method including:
a step of determining a model of an object of a display-target user on the basis of a distance score indicating the relationship from the display-target user to a user of a user terminal; and
a step of displaying the object of the display-target user on the user terminal on the basis of the determined model of the object.

[9] According to one embodiment, the present invention provides a method according to [8], further including a step of calculating a distance score indicating the relationship from one user to another user,
wherein, in the step of determining, a model of an object of a display-target user is determined on the basis of a distance score indicating the relationship from the display-target user to the user of the user terminal, the distance score being calculated in the step of calculating.

According to one embodiment, the present invention provides a program causing a computer to execute the steps in the method according to [8] or [9].

According to one embodiment, the present invention provides a user terminal for displaying an object of a user in a virtual space, the user terminal including:
storing a model of an object of another user corresponding to a distance score indicating the relationship from said another user to a user of the user terminal; and
determining a model of an object of a display-target user on the basis of a score indicating the relationship from the display-target user to the user of the user terminal, the score being stored in the distance score storage unit, and displaying the object of the display-target user on the basis of the determined model of the object.

According to one embodiment, the present invention provides a server for displaying, on a user terminal, an object of a user in a virtual space, the server including:
storing a distance score indicating the relationship from one user to another user; and
determining a model of an object of a display-target user on the basis of a distance score indicating the relationship from the display-target user to a user of the user terminal, the distance score being stored in the distance score storage unit, and performing control so as to display the object of the display-target user on the user terminal on the basis of the determined model of the object.

### Advantageous Effects of Invention

According to the present invention, it is possible to perform control of appearance according to the relationship between users in a virtual space.

### BRIEF DESCRIPTION OF DRAWINGS

FIG. 1 is a view showing the overall configuration of a system of one embodiment of the present invention.

FIG. 2 is a block diagram showing the hardware configuration of a server of one embodiment of the present invention.

FIG. 3 is a block diagram showing the hardware configuration of a user terminal of one embodiment of the present invention.

FIG. 4 is a functional block diagram of the system of the embodiment of the present invention.

FIG. 5 is a view showing examples of multiple stages of models of an avatar of a user that are stored in an object model storage unit.

FIG. 6 is a view showing an example of a flowchart of processing in the system of the present invention.

### DESCRIPTION OF EMBODIMENTS

An embodiment of the present invention will be described below with reference to the drawings. A system according to the embodiment of the present invention can provide a virtual space (virtual world), such as a metaverse, to users. For example, a system 1 enables a user to act in a virtual space via an avatar that is an alter ego of the user. In the embodiment of the present invention, a metaverse means a virtual space on the Internet and a service therein and can also mean a metaverse service and a metaverse platform. In the embodiment of the present invention, although a metaverse that means a virtual space on the Internet is simply expressed as a virtual space, the embodiment of the present invention can also be applied to a virtual space that has the same functions as a metaverse. An avatar of a user, i.e., an avatar representing a user, is one example of a character representing a user in a virtual space. In this specification, an SNS (social networking service) can include services or general websites that enable or that support building of social networks. In this specification, apps are not limited to apps installed in mobile terminals such as smartphones and can mean general applications and general programs. In this specification, expressions such as a user A and a user B indicate arbitrary users and are used to indicate that the user A and the user B are different users.

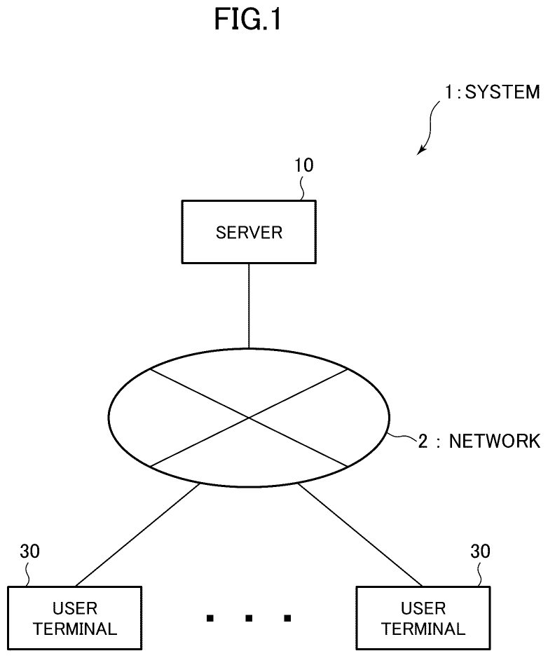

FIG. 1 is a view showing the overall configuration of the system 1 of the embodiment of the present invention. As shown in FIG. 1, the system 1 includes a server 10 and a plurality of user terminals 30, and the server 10 and the user terminals 30 are connected to a network 2 such as the Internet and can communicate with one another. Although a description will be given on the assumption that the system 1 of the embodiment of the present invention is a known client-server system, the system 1 is not limited thereto.

The server 10 is a server or a server system that is configured by including one or a plurality of devices and that can provide a metaverse to users. In the embodiment of the present invention, the server 10 includes an SNS server (a web server or an application server) capable of providing a known social networking service (SNS) in a virtual space (metaverse) or includes functions of the SNS server. The server 10 may be realized by a virtual machine or a cloud system. The server 10 accepts an access from a user terminal 30 and provides a metaverse for the user thereof via the network 2. For example, when the user terminal 30 connects to the server 10 via a predetermined app or a standardly implemented web browser and is identified and authenticated by using a user ID, a password, etc., it is possible to use the metaverse as the user of the user ID. In one example, the server 10 includes a server operated by a company that provides a known metaverse (metaverse platform) or includes functions of the server. For convenience of explanation, a description will be given below on the assumption that the server 10 is realized by one device.

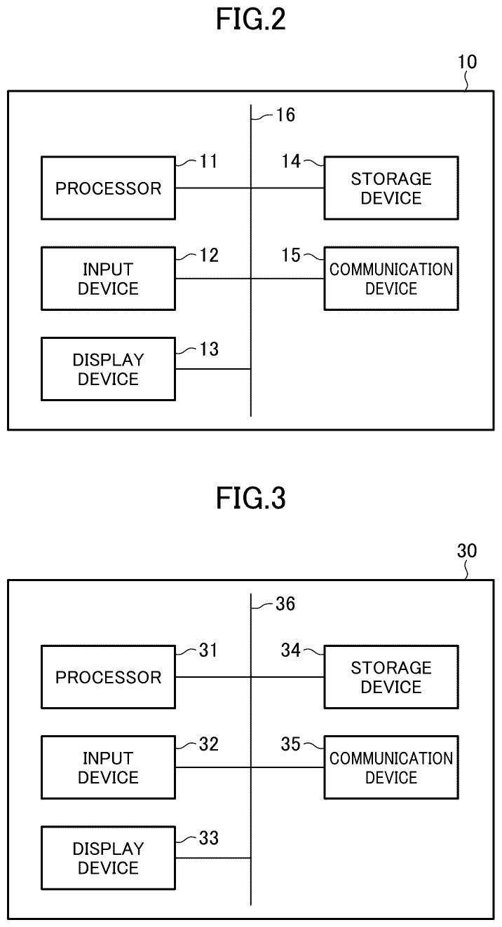

FIG. 2 is a block diagram showing the hardware configuration of the server 10 of the embodiment of the present invention. The server 10 includes a processor 11, an input device 12, a display device 13, a storage device 14, and a communication device 15. These individual constituent devices are connected by a bus 16. Note that it is assumed that interfaces are interposed as needed between the bus 16 and the individual constituent devices. The server 10 can include constituents similar to those of general servers, PCs, or the like.

The processor 11 controls the overall operations of the server 10. For example, the processor 11 is a CPU. The processor 11 executes various kinds of processing by loading programs and data stored in the storage device 14 and executing the programs. The processor 11 may be constituted of a plurality of processors.

The input device 12 is a user interface for accepting inputs from a user to the server 10 and is, for example, a touchscreen, a touchpad, a keyboard, a mouse, or a button. The display device 13 is a display for displaying an application screen etc. to the user of the server 10 under the control of the processor 11.

The storage device 14 includes a main storage device and an auxiliary storage device. The main storage device is, for example, a semiconductor memory such as a RAM. The RAM is a volatile storage medium capable of high-speed reading and writing of information and is used as a storage area and a work area when the processor 11 processes information. The main storage device may include a ROM that is a read-only non-volatile storage medium. The auxiliary storage device stores various programs and data used by the processor 11 when the programs are executed. The auxiliary storage device may be any non-volatile storage or non-volatile memory as long as it can store information and may be detachable.

The communication device 15 sends data to and receives data from the other computers, such as the user terminals or a server, via the network and is, for example, a wireless LAN module. The communication device 15 can also be another wireless-communication device or module, such as a Bluetooth (registered trademark) module, or can also be a wired-communication device or module, such as an Ethernet (registered trademark) module or a USB interface.

FIG. 3 is a block diagram showing the hardware configuration of each of the user terminals 30 of the embodiment of the present invention. The user terminal 30 includes a processor 31, an input device 32, a display device 33, a storage device 34, and a communication device 35. These individual constituent devices are connected by a bus 36. Note that it is assumed that interfaces are interposed as needed between the bus 36 and the individual constituent devices. In the embodiment of the present invention, the user terminal 30 can be a head-mounted display terminal (HMD terminal). In the following explanation of the hardware configuration, the user terminal 30 that is an HMD terminal will be described.

The processor 31 controls the overall operations of the user terminal 30. For example, the processor 31 includes a CPU and executes various kinds of processing by loading programs and data stored in the storage device 34 and executing the programs. For example, the processor 31 includes a GPU for performing drawing processing and generates a virtual space image to be presented to a user wearing an HMD. The processor 31 may be constituted of a plurality of processors.

The input device 32 is a user interface for accepting inputs from the user to the user terminal 30. In one example, the input device 32 is a controller separated from a main body that the user wears on the head. In this case, the main body and the controller are configured so as to be able to communicate with each other. In one example, the input device 32 is a sensor for detecting movements of hands of the user, such as an imaging device.

The display device 33 is a display for displaying an application screen etc. to the user under the control of the processor 31. The display device 33 is a non-transmissive display, such as a liquid crystal display or an organic EL display, and displays a virtual space image to the user wearing the HMD. For example, the user terminal 30 can be a general fully immersive HMD or video see-through HMD. For example, when the user terminal 30 is a video see-through HMD, the user terminal 30 includes an imaging device attached so as to image the user's field of view when the user wears the user terminal 30.

The storage device 34 includes a main storage device and an auxiliary storage device. The main storage device is, for example, a semiconductor memory such as a RAM. The RAM is a volatile storage medium capable of high-speed reading and writing of information and is used as a storage area and a work area when the processor 31 processes information. The main storage device may include a ROM that is a read-only non-volatile storage medium. The auxiliary storage device stores various programs and data used by the processor 31 when the programs are executed. The auxiliary storage device may be any non-volatile storage or non-volatile memory as long as it can store information and may be detachable.

The communication device 35 sends data to and receives data from the other computers, such as the user terminals or the server, via the network, and is, for example, a wireless LAN module. The communication device 35 can also be another wireless-communication device or module, such as a Bluetooth (registered trademark) module, or can also be a wired-communication device or module, such as an Ethernet (registered trademark) module or a USB interface.

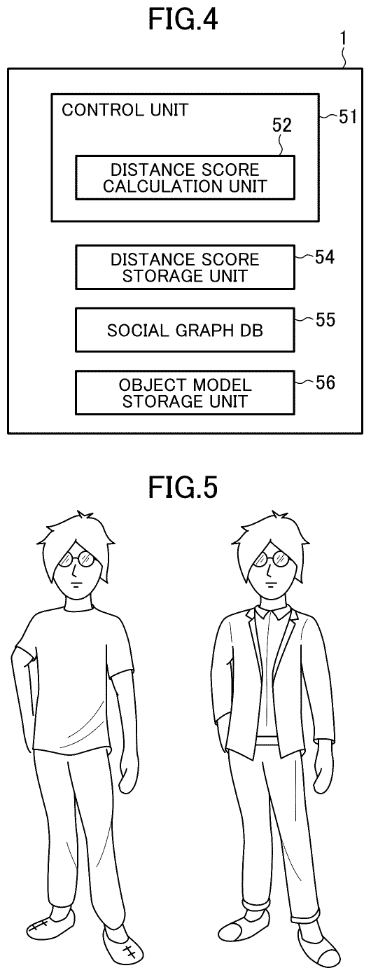

FIG. 4 is a functional block diagram of the system 1 of the embodiment of the present invention. The system 1 includes a control unit 51, a distance score storage unit 54, a social graph DB (social graph database) 55, and an object model storage unit 56. The control unit 51 includes a distance score calculation unit 52. These functions of the system 1 can be realized when the server 10 and the user terminal 30 execute processing procedures similar to those executed by a server and a client in a known client-server system. For example, these functions are realized (1) when the processor 11 of the server 10 executes a program and stores data in the storage device 14 as needed, (2) when the processor 31 of the user terminal 30 executes a program and stores data in the storage device 34 as needed, or (3) when the processor 11 executes a program and stores data in the storage device 14 as needed, and the processor 31 executes a program and stores data in the storage device 34 as needed, or are realized (4) when, in addition to any of these, data is sent and received between the server 10 and the user terminal 30 as needed. In this way, since various kinds of functions are realized by loading a program, a part or the entirety of one functional unit (for example, software module) may be included in another functional unit, or the control unit 51 may have another functional unit other than those described above. Note that at least one of the distance score storage unit 54, the social graph DB 55, and the object model storage unit 56 may be realized by only the storage device 34. In one modification, each of the functional units included in the system 1 may be realized in hardware by configuring an electronic circuit etc. for realizing a part or the entirety thereof.

The control unit 51 includes a function of providing a metaverse. In one example, the user terminal 30 is an HMD terminal in which a terminal app Q has been installed, and, when the app Q is launched on the user terminal 30, the user terminal 30 communicates with the server 10 in which a server app P is executed. The server 10 sends and receives, to and from the user terminal 30, data required to provide a service. In one example, while the app Q is launched (executed) on the user terminal 30, the server 10 periodically or intermittently communicates with this user terminal 30 and performs processing for moving an avatar, for example, according to operation inputs performed at this user terminal 30. In one example, the server 10 in which the app P is being executed has a server-side function for providing a metaverse, and the user terminal 30 in which the app Q is being executed has a client-side function for providing a metaverse.

In the embodiment of the present invention, the server 10 stores, in the storage device 14, a user ID and user information in association with each other. In one example, the user information includes: information about a user in the real world, such as a user name and a mail address; and information about the user in a virtual space, such as an avatar of the user. In one example, the server 10 receives a user ID and a password from the user terminal 30 to authenticate the user and provides a metaverse to the user terminal 30 by using data stored in association with the user ID of the authenticated user. Once the user ID is authenticated, the control unit 51 provides a metaverse on the basis of the user information associated with the user ID and stores data in association with the user ID, until the metaverse is finished or a logout operation is accepted. Since, once the user ID is authenticated, the control unit 51 stores data in association with the user ID until the metaverse is finished or a logout operation is accepted, in the following explanation, storing data in association with the user ID is simply expressed as storing data, in some cases.

In general, an operator who operates an avatar is a user, and a user to be identified by the system 1 (the control unit 51) is a user ID or an account. In this specification, a “personal-account user” indicates a user who is a natural person, and a “non-personal-account user” indicates a user who is not a natural person (for example, a corporate user). For example, a non-personal-account user is a corporate having (capable of creating) an official account on an SNS such as twitter and LINE and is a user of an account existing in a virtual space. An account is the right to use a metaverse (metaverse service) and can be a set of a user ID and user information linked to the user ID.

The control unit 51 enables a personal-account user to act in a virtual space via an avatar that is an alter ego of the user. In a metaverse (in a virtual space), for a personal-account user, an avatar represents the user himself/herself. Therefore, for example, the field of view of the avatar of the user is expressed as the field of view of the user, and the avatar of the user (the avatar representing the user) in a virtual space is expressed as the user in a virtual space, in some cases. For example, as in a known metaverse, for personal-account users, in the case where a personal-account user A (an avatar of the user A) is present in the field of view of another user B in a virtual space, the control unit 51 displays (renders), on the display device 33 of the user terminal 30 of the user B, a virtual space (metaverse) including the avatar of the user A having a size corresponding to the distance from the avatar of the user B to the avatar of the user A in the virtual space. Note that, in the embodiment of the present invention, displaying (rendering) a virtual space including an avatar is simply expressed as displaying an avatar, in some cases. The control unit 51 enables a non-personal-account user to provide, via an environment such as a location, a service to other users in a virtual space. In the embodiment of the present invention, a user whose character (for example, avatar) or environment (for example, location) is viewed by the other user(s) is expressed as a display-target user, in some cases.

The social graph DB 55 stores data of a social graph accumulated in an SNS. In the embodiment of the present invention, the server 10 includes the social graph DB 55. The social graph can include a social graph in general sense or a data structure thereof. Furthermore, the social graph can include a data structure that defines correlation and intimacy between a plurality of humans and services. The social graph is a network structure expressed as a graph G=(V,E), where V indicates a vertex set, and E indicates an edge set. For example, in an SNS like Facebook in which users can be friends only when they send and accept a friend request, the graph G is an undirected graph with no weights, and, in an SNS like Twitter in which users can perform one-way following, the graph G is a directed graph with weights.

The distance score calculation unit 52 calculates a distance score indicating the relationship from one user to another user. In the embodiment of the present invention, the server 10 includes the distance score calculation unit 52. In the embodiment of the present invention, the distance score indicates the distance in a social graph, and the distance score calculation unit 52 calculates the distance in a graph G from one user to another user. However, the distance score may also be a value corresponding to the distance in a social graph. The distance score calculation unit 52 calculates the distance in the graph G between users by applying a known distance function (for example, any of the distance functions shown in Non-Patent Literatures 1 to 3).

When calculating the distance (distance score) between a user A and a user B, the distance score calculation unit 52 calculates the distance from the user A to the user B and the distance from the user B to the user A. Here, the distance from the user A to the user B and the distance from the user B to the user A are not always equal to each other. This is because, for example, even if the user A has an intention of unilaterally wanting to shorten the distance to the user B, the user B might have an intention of not wanting to shorten the distance to the user A.

In one example, the distance score calculation unit 52 calculates a distance score that indicates the relationship from one user to another user on the basis of a weight that is set for said another user by said one user. In one example, the distance score calculation unit 52 calculates a distance score that indicates the relationship from one user to another user on the basis of the number of links between the nodes of said one user and said another user, the nodes indicating individual users in a social graph.

In one example, the distance score calculation unit 52 is defined as a function of calculating the distance from the user A to the user B as a number, as shown in Expression (1).

$$graph\_distance ( User A , User B ) \to number \qquad ( 1 )$$

The distance score storage unit 54 stores the distance score indicating the relationship from one user (display-target user) to another user (user of the user terminal 30 on which the avatar of the display-target user is displayed), i.e., the distance score from the display-target user to the user of the user terminal 30, calculated by the distance score calculation unit 52. In the embodiment of the present invention, the server 10 includes the distance score storage unit 54. In one example, the distance score storage unit 54 stores a table in which the identifier (for example, the user ID) of one user, the identifier (for example, the user ID) of another user, and the distance score are linked, as shown in Expression (2).

$$scache = [ 〈 {user}_{1} , {user}_{2} , {score}_{12} 〉 , \\ 〈 {user}_{1} , {user}_{3} , {score}_{13} 〉 , … , 〈 {user}_{m} , {user}_{n} , {score}_{mn} 〉 ] \qquad ( 2 )$$

The object model storage unit 56 stores, for each of personal account users, multiple stages of avatar models corresponding to the distance scores indicating the relationships from this user to other users, while linking the avatar models to the user ID, for example. In one example, an avatar model corresponding to the smallest distance score is an avatar model for family or best friends. In the embodiment of the present invention, the server 10 includes the object model storage unit 56.

FIG. 5 is a view showing examples of multiple stages of avatar models of a user that are stored in the object model storage unit 56. An avatar on the left side in FIG. 5 is an avatar model corresponding to a distance score N (N is a predetermined value) or less and shows a relatively casual model. On the other hand, an avatar on the right side in FIG. 5 is an avatar model corresponding to a distance score greater than the distance score N and shows a relatively formal model. As shown in FIG. 5, a plurality of user's avatars linked to one user ID are avatars that can be recognized as the same person even though the clothes etc. are different. For convenience of explanation, two avatar models are shown in FIG. 5, but the number of avatar models and the clothes etc. are not limited thereto.

The control unit 51 accepts, from a personal-account user, an input of an avatar (avatar data) via the user terminal 30. For example, the control unit 51 receives avatar data from a user or accepts an avatar creation input from a user by a known method. The control unit 51 stores the avatar of which the input has been accepted from the user, in the object model storage unit 56 as a model of the avatar of the user. In the embodiment of the present invention, the control unit 51 accepts, from a personal-account user, inputs of a plurality of avatars corresponding to intimacies (distance scores). The number of avatars of which inputs are accepted by the control unit 51 and the magnitudes of distance scores made to correspond to the avatars can be set arbitrarily.

In one example, from each of personal-account users, the control unit 51 accepts inputs of the avatar of: a model for family corresponding to a distance score DS1 or less (0≤DS≤1); a model for best friends corresponding to a distance score DS3 or less (1<DS≤3); a model for friends corresponding to a distance score DS4 or less (3<DS≤4); and a model for others corresponding to the other distance scores (DS>4). The object model storage unit 56 stores, for each user, pieces of avatar data corresponding to these distance scores, as avatar models. In one example, the object model storage unit 56 is realized as a database, and search processing in this database is defined as processing of searching for a model, of a certain user, corresponding to a distance score or less, as shown in Expression (3).

$$find\_model ( user , score ) \to model \qquad ( 3 )$$

The control unit 51 selects (determines), as a model of the avatar of a display-target user, one of avatar models stored in the object model storage unit 56, on the basis of the distance score that indicates the relationship from the display-target user to the user of the user terminal 30 and that is stored in the distance score storage unit 54, i.e., on the basis of the distance score from the display-target user to the user of the user terminal 30. The control unit 51 performs control so as to display (render), on the user terminal 30, the avatar of the display-target user on the basis of the selected avatar model.

When the avatar of another personal-account user B is present in the field of view of a personal-account user A (the field of view of the avatar of the user A) in a virtual space, the control unit 51 selects an avatar model that corresponds to the distance from the user B to the user A from among avatar models stored in association with the user ID of the user B and displays, using the selected model, the avatar of the user B on the user terminal 30 of the user A. For example, in the case where the object model storage unit 56 stores, for the avatar of the user B, avatar models that correspond to three distance scores, i.e., a distance score 1 or less, a distance score 3 or less, and the other distance score, when the distance score from the user B to the user A is 2.5, the control unit 51 selects an avatar model that corresponds to the distance score 3 or less.

In the embodiment of the present invention, in the case where there is a need to display the avatar of the other personal-account user B, such as a case where the avatar of the user B might come into the field of view of the personal-account user A in a virtual space, if a model of the avatar has not been stored, the user terminal 30 requests a model of the avatar to the server 10 and receives the model of the avatar from the server 10. The user terminal 30 stores, in the storage device 34 of the user terminal 30, the received model of the avatar of the user B in association with the user ID of the user B. When the avatar of the user B comes into the field of view of the user A, the user terminal 30 uses the model of the avatar of the user B to display (render) a virtual space including the avatar of the user B.

In one example, the function in which the user terminal 30 of the user A requests a model of the avatar of the other user B to the server 10 is defined as a function of searching for a model of the avatar of another user (display-target user) viewed from the user A, as shown in Expression (4).

$$get\_model ( User 1 , User 2 ) \to model \qquad ( 4 )$$

In one example, the user terminal 30 of the user stores a table in which the identifier (for example, the user ID) of another user and a model of the avatar thereof are linked, as shown in Expression (5). With this table, the user terminal 30 stores a model of the avatar of another user received from the server 10 in response to a request to the server 10.

$$mcache = [ 〈 {user}_{1} , {model}_{1} 〉 , 〈 {user}_{2} , {model}_{2} 〉 , … , 〈 {user}_{n} , {model}_{n} 〉 ] \qquad ( 5 )$$

In the above-described embodiment of the present invention, the server 10 includes at least a part of the control unit 51 and includes the distance score calculation unit 52, the distance score storage unit 54, the social graph DB 55, and the object model storage unit 56. Furthermore, in the above-described embodiment of the present invention, the user terminal 30 includes at least a part of the control unit 51, includes a function of requesting a model of an avatar to the server 10 and a function of storing a model of the avatar of another user received from the server 10, and does not include the distance score calculation unit 52, the distance score storage unit 54, the social graph DB 55, and the object model storage unit 56.

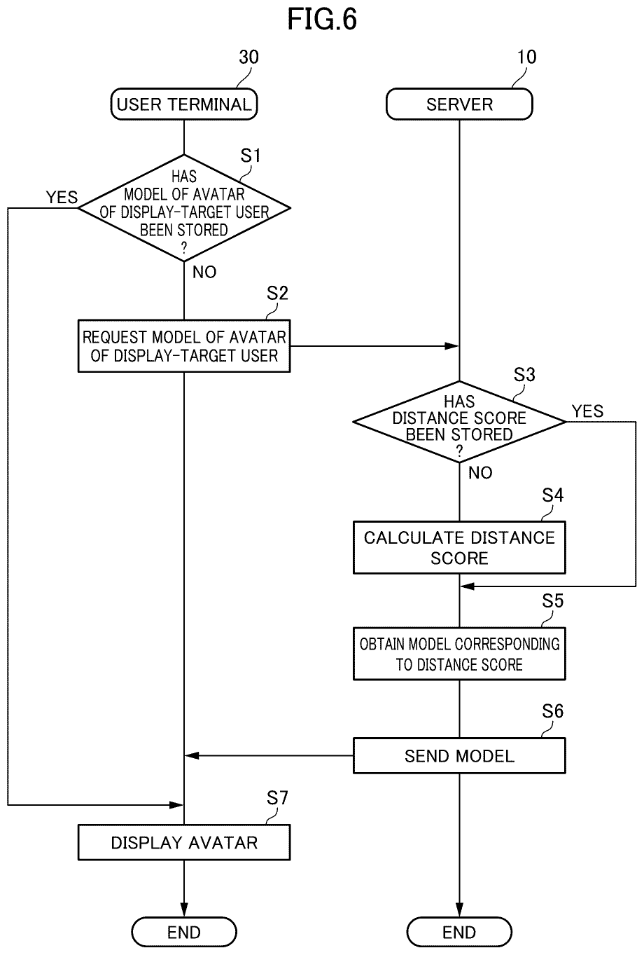

FIG. 6 is a view showing an example of a flowchart of processing in the system 1 of the present invention. Note that, although the flowchart indicates processing related to displaying (rendering) an avatar, processing related to displaying (rendering) an environment etc. is similar.

In Step S1, in the case where there is a need to display the avatar of the other user B, such as a case where the avatar of the user B might come into the field of view of the user A in a virtual space, the user terminal 30 of the user A determines whether a model of the avatar of the user B, which is a display-target user, has been stored or not. If a model of the avatar of the display-target user B has been stored, the flowchart proceeds to Step S7. If a model of the avatar of the display-target user B has not been stored, the flowchart proceeds to Step S2.

In Step S2, the user terminal 30 sends a request for a model of the avatar of the display-target user B to the server 10.

In Step S3, the server 10 determines whether or not the distance score storage unit 54 has stored a distance score from the display-target user B to the user A of the user terminal 30. If this distance score has been stored, the flowchart proceeds to Step S5. If this distance score has not been stored, the flowchart proceeds to Step S4.

In Step S4, the distance score calculation unit 52 calculates a distance score from the display-target user B, which is stored in the social graph DB 55, to the user A of the user terminal 30, that is, a distance score indicating the relationship from the display-target user B to the user A.

In Step S5, the control unit 51 obtains (determines), from among models of the avatar of the display-target user B that are stored in the object model storage unit 56, a model of the avatar that corresponds to the distance score from the display-target user B to the user A of the user terminal 30.

In Step S6, the control unit 51 sends the obtained (determined) model of the avatar to the user terminal 30 from which the request has been accepted in Step S2.

In Step S7, the user terminal 30 displays a virtual space including the avatar of the user B, by using the model of the avatar of the display-target user B.

Next, main advantageous effects of the system 1 of the embodiment of the present invention will be described below. In the embodiment of the present invention, the distance score storage unit 54 stores a distance score indicating the relationship from one user to another user, and the control unit 51 determines (selects) a model of the avatar of the display-target user on the basis of the distance score indicating the relationship from the display-target user to the user of the user terminal 30, the distance score being stored in the distance score storage unit 54, and performs control so as to display, on the user terminal 30, the avatar of the display-target user on the basis of the determined model of the avatar.

With this configuration, in this embodiment, it is possible to change the appearance of oneself (for example, a model of the avatar of oneself) depending on another person in a metaverse, that is, to perform control of appearance according to the relationship between users. Furthermore, it is possible to realize a function that appeals to a universal human interest, “the human appearance is the first social message”, and that is specific to a metaverse, “the appearance of oneself is dynamically selected depending on a person who sees oneself”, which is impossible in the physical space.

Furthermore, with the above-described configuration of this embodiment, “control of appearance according to the social relationship” is realized, in which, when the display device 33 corresponding to the field of view of a particular user is rendered, in addition to the physical distance in a virtual space between oneself and another user present in the visible range of said particular user, the distance relationship in a social network, i.e., “intimacy”, between oneself and said another user is measured, and a display model of said another user is obtained according to the distance to perform rendering. This rendering processing, in which the distance in a social network and the distance relationship in a metaverse 3D space are integrated, is realized for the first time with the configuration of this embodiment.

For example, in an SNS, the sociality is conventionally implemented by controlling the visibility of information through two mechanisms, social graph and timeline. On the other hand, since a metaverse system relies heavily on analogy of a physical space, when information is rendered on a 3D space, a natural 3D space cannot be implemented by simply controlling the visibility of the information. In order to implement sociality in the metaverse era, it is not enough to control the visibility of information, but it is necessary to control the appearance of information. With the configuration of this embodiment, it is possible to provide a general-purpose model for controlling appearances as a whole in a metaverse.

Furthermore, in this embodiment, the object model storage unit 56 stores, for each user, multiple stages of avatar models corresponding to the distance scores indicating the relationships from the user to other users. With this configuration, the user can set, as the avatar of himself/herself, for example, a model that is open to “public”, a model for “friends”, a model that can be open up to “friends of friends”, a model for “friends other than the following (exclude)”, a model for “some friends (include)”, a model that is displayed to “only oneself”, a model for “custom (group or the like)”, and the appearance of oneself when viewed from others can be automatically changed according to relationships on an SNS. Accordingly, the avatar can be displayed differently depending on the other persons; for example, when a user meets a friend and a boss by chance and at the same time in a shopping mall in a metaverse, the user's avatar is rendered as a mob character when viewed from the boss and is rendered as a punk rock style avatar when viewed from the friend.

The above-described advantageous effects are the same in other embodiments or modifications unless otherwise noted.

As described above, the embodiment of the present invention can provide the system 1, the server 10, or the user terminal 30. The embodiment of the present invention can also provide a method or a program for realizing the above-described functions of the system 1, the server 10, or the user terminal 30 and the above-described information processing shown in the flowchart or a computer-readable storage medium that has stored this program. Furthermore, the embodiment of the present invention can also provide a server capable of supplying, to a computer, a program for realizing the above-described functions of the embodiment of the present invention and the above-described information processing shown in the flowchart.

In one or a plurality of embodiments of the present invention, the control unit 51 can accept, from a non-personal-account user, an input of an environment in a virtual space. For example, an environment in a virtual space is a building, a landscape, or a designed space (for example, a town) in the virtual space and is managed and operated by the non-personal-account user. In one example, a non-personal-account user is a local government such as a prefecture, and this user can manage a town in a virtual space. In one example, a non-personal-account user is an official-account user such as a company etc., and this user can manage a space (for example, shopping mall facilities) in a virtual space. Like avatars, the number of environments of which inputs are accepted by the control unit 51 and the magnitudes of distance scores made to correspond to the environments can be set arbitrarily. When an environment of one non-personal-account user A is present in the field of view of one personal-account user B in a virtual space, the control unit 51 can display (render) a virtual space (metaverse) including a scenery created by the environment of the user A having a size according to the distance from the user B to the user A in the virtual space, on the display device 33 of the user terminal 30 of the user B. The distance score calculation unit 52 can calculate the distance score between a personal-account user and a non-personal-account user and can also calculate the distance score between non-personal-account users. For example, the distance score calculation unit 52 can calculate the distance from a non-personal-account user to a personal-account user and the distance from a personal-account user to a non-personal-account user. For example, the distance score calculation unit 52 can calculate the distance from a personal-account user to a non-personal-account user according to whether or not the personal-account user follows the non-personal-account user, the numbers of retweets and likes, etc. Therefore, the distance score storage unit 54 can store distance scores related to non-personal-account users. For example, the distance score storage unit 54 can store a distance score indicating the relationship from one non-personal-account user A to another one personal-account user B.

In one or a plurality of embodiments of the present invention, for example, things including an avatar and an environment to be drawn in a virtual space can be expressed as objects. The object model storage unit 56 stores models of objects and can store, for each of non-personal-account users, multiple stages of models of an environment that correspond to distance scores indicating the relationships from this user to other users. When an environment of another non-personal-account user B is present in the field of view of a personal-account user A in a virtual space, the control unit 51 can display, on the user terminal 30 of the user A, the environment of the user B by using a model of the environment that corresponds to the distance from the user B to the user A among models of the environment that are stored in association with the user ID of the user B. With this configuration, for example, “Akihabara that looks healthy to non-Otaku users”, “Kabukicho that looks like an ordinary office district to children”, “Ikebukuro that looks healthy to non-Fujoshi users”, etc., can be implemented.

In one or a plurality of embodiments of the present invention, for non-personal-account users, instead of environments in a virtual space, items in a virtual space, such as goods, products, etc., in a virtual space, can be displayed. For example, in this case, the control unit 51 can accept, from users, inputs of products in a virtual space, and the object model storage unit 56 can store, for each user, multiple stages of models of a product that correspond to distance scores indicating the relationships from this user to other users. For example, in this case, when a product of another non-personal-account user B is present in the field of view of a personal-account user A in a virtual space, the control unit 51 can display, on the user terminal 30 of the user A, the product of the user B by using a model of the product that corresponds to the distance from the user B to the user A among models of the product that are stored in association with the user ID of the user B.

In one or a plurality of embodiments of the present invention, in the case where there is a need to display an avatar of another personal-account user B since the avatar of the user B might come into the field of view of a personal-account user A in a virtual space, if the avatars of the user A and the user B are present in an environment of a non-personal-account user C, the user terminal 30 can display, on the user terminal 30 of the user A, the avatar of the user B in the environment of the user C by using a model of the environment of the user C that corresponds to the distance from the user C to the user A and by using a model of the avatar of the user B that corresponds to the distance from the user B to the user A. In one example, a non-personal-account user is an official-account user such as a company, and this user can manage services and products in a virtual space.

In a modification of the present invention, in the case where there is a need to display an avatar of another personal-account user B since the avatar of the user B might come into the field of view of a personal-account user A in a virtual space, if the avatars of the user A and the user B are present in an environment of a non-personal-account user C, the user terminal 30 can display, on the user terminal 30 of the user A, the avatar of the user B in the environment of the user C by using a model of the environment of the user C that corresponds to the distance from the user B to the user C and by using a model of the avatar of the user B that corresponds to the distance from the user B to the user C. With this configuration, automatic model selection according to TPO on a metaverse space becomes possible by using, as a relationship on an SNS, the relationship between oneself and not only a specific individual but also “a service”. For example, it is possible to seamlessly move back and forth between services on metaverses with a model in everyday clothes when participating in a general service such as shopping and with a fantasy-style model when participating in a game service.

In one or a plurality of embodiments of the present invention, the control unit 51 enables a non-personal-account user to act in a virtual space via an avatar that is an alter ego of the user, in the same way as for a personal-account user. In this case, it is also possible to configure the control unit 51 so as not to accept, from the user, an input of an environment in a virtual space.

In one or a plurality of embodiments of the present invention, the server 10 can also cooperate with a known SNS server to provide a metaverse, and, in this case, the server 10 does not need to include an SNS server or the functions thereof. For example, in this case, the server 10 just needs to be able to identify user IDs and does not need to store user IDs and user information in association with each other.

In one or a plurality of embodiments of the present invention, in the case where the system 1 is configured to be able to communicate with an external device that includes the distance score calculation unit 52, the system 1 does not need to include the distance score calculation unit 52. In one or a plurality of embodiments of the present invention, in the case where the system 1 is configured to be able to communicate with an external device that includes the social graph DB 55, the system 1 does not need to include the social graph DB 55. In one or a plurality of embodiments of the present invention, in the case where the system 1 is configured to be able to communicate with an external device that includes the object model storage unit 56, the system 1 does not need to include the object model storage unit 56.

In one or a plurality of embodiments of the present invention, in the case where an SNS that is provided by the system 1 or with which the system 1 is cooperated is an omnidirectional SNS, the table stored in the distance score storage unit 54 can include one distance score between users.

In one or a plurality of embodiments of the present invention, it is also possible that the control unit 51 accepts an input of only one avatar from a user via the user terminal 30, and the object model storage unit 56 stores only one model of the avatar for one user ID. Even in the case where the system 1 does not include the object model storage unit 56, the control unit 51 can determine a model of the avatar of a display-target user on the basis of the distance score indicating the relationship from the display-target user to the user of the user terminal 30, which is stored in the distance score storage unit 54, and perform control so as to display, on the user terminal 30, the avatar of the display-target user on the basis of the determined model of the avatar. For example, in this case, it is possible to configure the control unit 51 so as to store correction data, such as clothes corresponding to distance scores, and automatically change the model of the avatar according to the distance score on the basis of the correction data. The above-described embodiment can be similarly applied to environments, items, etc.

In one or a plurality of embodiments of the present invention, the system 1 or the server 10 can be a system or a server that supports an existing metaverse system and that includes: the function of the distance score storage unit 54; and, of the functions of the control unit 51, the functions of determining (selecting) a model of an object of a display-target user on the basis of the distance score indicating the relationship from the display-target user to the user of the user terminal 30, which is stored in the distance score storage unit 54, and of supporting to display, on the user terminal 30, the object of the display-target user on the basis of the determined model of the object.

In one or a plurality of embodiments of the present invention, the display device 33 can be formed of a transmissive display, and, in this case, the user terminal 30 is an optical see-through HMD. The user terminal 30, serving as an optical see-through HMD, enables a user who wears the HMD to view the real space through the transmissive display and draws a virtual object superimposed on the transmissive display, thereby making it possible to provide augmented reality imagery and mixed reality imagery. Furthermore, in one or a plurality of embodiments of the present invention, one or a plurality of user terminals 30 can also be a wearable terminal(s), such as smart glasses, including the same functions as those of any type of an HMD terminal.

In one or a plurality of embodiments of the present invention, one or a plurality of user terminals 30 can be a general personal computer(s). For example, the user terminal(s) 30 can be a terminal(s) such as a smartphone(s), a tablet computer(s), etc. In this case, the user terminal(s) 30 includes the processor 31, the input device 32, the display device 33, the storage device 34, and the communication device 35, which correspond to the processor 11, the input device 12, the display device 13, the storage device 14, and the communication device 15, respectively. In the case where the user terminal 30 is a personal computer, it is possible that a head-mounted display terminal (HMD terminal) is connected to the computer, a controller of the HMD terminal is provided as the input device 32, and a display of the HMD terminal is provided as the display device 33. Note that, since it is assumed that a non-personal-account user does not act in a virtual space via an avatar, it is assumed that the user uses, as the user terminal 30, a personal computer instead of an HMD terminal.

In one or a plurality of embodiments of the present invention, when an avatar of a personal-account or non-personal-account user A is present in a virtual space in a state in which the user A has not been registered in an SNS or in a state in which personal information of the user A has not been registered in an SNS, the control unit 51 can display an avatar of another user in such a manner that this avatar or the user of this avatar cannot be identified. In one example, in the case where the avatar of the user A is present in a virtual space in a state in which the user A has not been registered in an SNS or in a state in which personal information of the user A has not been registered in an SNS, when the user terminal 30 of the user A requests a model of an avatar of another user B to the server 10 by using Expression (4), the server 10 returns, as a model of the avatar of the user B, a model model_{unknown} by which the avatar of the user B cannot be identified. For example, the server 10 determines whether the distance score can be calculated or not in Step S4 and, if the distance score cannot be calculated, obtains a model model_{unknown}, by which the avatar of the user for which the request has been accepted cannot be identified, from the object model storage unit 56 in Step S5, and sends the obtained model model_{unknown} to the user terminal 30 from which the request has been accepted in Step S2, in Step S6. In this case, the user terminal 30 of the user A stores, for example, a table shown in Expression (6).

$$mcache = [ 〈 {user}_{1} , {model}_{unknown} 〉 , \\ 〈 {user}_{2} , {model}_{unknown} 〉 , … , 〈 {user}_{n} , {model}_{unknown} 〉 ] \qquad ( 6 )$$

In one or a plurality of embodiments of the present invention, when the avatar of a personal-account or non-personal-account user A is present in a virtual space while information of the user A does not exist or has not yet been registered on an SNS, the control unit 51 can also display environments and items of other users in such a manner that the environments and the items cannot be identified.

In one or a plurality of embodiments of the present invention, the user terminal 30 does not need to include a function of storing a model of an avatar of another user received from the server 10. In this case, when a model of an avatar of a display-target user is needed, the user terminal 30 can display the avatar by using a model of the avatar requested to the server 10 and received from the server 10.

In one or a plurality of embodiments of the present invention, the user terminal 30 may be configured as a thin client terminal for input/output. In this case, the user terminal 30 does not include a function of requesting a model of an avatar to the server 10 and a function of storing a model of an avatar of another user received from the server 10, and the server 10 includes the functions of the system 1 except for the I/O functions of the user terminal 30.

In one or a plurality of embodiments of the present invention, the flowchart shown in FIG. 6 may also be configured such that, in the case where the user terminal 30 of a user A needs to display an avatar or an environment of another user B, even if it is determined in Step S1 that a model of the avatar or the environment of the display-target user B has been stored, the flowchart advances to Step S2 when a predetermined period of time has elapsed. With this configuration, a model stored in the object model storage unit 56 is updated, thereby making it possible to prevent a state in which this model and the model stored in the user terminal 30 are different from each other.

As described above, in one or a plurality of embodiments of the present invention, the system 1 can be configured of five modules, i.e., an object model cache, a graph distance cache, a graph distance function, a social graph DB, and a 3D object model DB. In this way, through modularization, a part of the modules can be changed and applied to the system.

The object model cache is a module for temporarily caching, in the user terminal 30, a model of an object (for example, an avatar or the like) corresponding to the distance on a social graph, and is a function provided in the individual user terminal 30. The object model cache has a function of caching data of the table shown in Expression (5), for example. The graph distance cache is a module having a function corresponding to the distance score storage unit 54 and is a function provided in the server 10. The graph distance function is a module having a function corresponding to the distance score calculation unit 52. The social graph DB is a module having a function corresponding to the social graph DB 55. The 3D object model DB is a module having a function corresponding to the object model storage unit 56.

In the case where there is a need to display an avatar of a certain user A, if a model of the avatar has not been stored, the object model cache requests a model of the avatar to the server 10. When the request is accepted, the graph distance cache obtains, from the 3D object model DB, a model corresponding to the distance score indicating the relationship from the user A to a user B of the user terminal 30 and sends the model to the user terminal 30 that has sent the request for the obtained model. In the case where the distance score indicating the relationship from the user A to the user B of the user terminal 30 has not been stored, the graph distance cache requests the graph distance function to calculate the distance score.

The processing or operation described above can be modified freely as long as no inconsistency arises in the processing or operation, such as an inconsistency that a certain step utilizes data that may not yet be available in that step. Furthermore, the examples described above are examples for explaining the present invention, and the present invention is not limited to those examples. The present invention can be embodied in various forms as long as there is no departure from the gist thereof.

### Reference Signs List

1: system, 2: network, 10: server, 11: processor, 12: input device, 13: display device, 14: storage device, 15: communication device, 16: bus, 30: user terminal, 31: processor, 32: input device, 33: display device, 34: storage device, 35: communication device, 36: bus, 51: control unit, 52: distance score calculation unit, 54: distance score storage unit, 55: social graph DB, 56: object model storage unit

1. A system for displaying an object of a user in a virtual space, the system comprising:
a distance score storage unit that stores a distance score indicating the relationship from one user to another user; and
a control unit that determines a model of an object of a display-target user on the basis of a distance score indicating the relationship from the display-target user to a user of a user terminal, the distance score being stored in the distance score storage unit, and performs control so as to display the object of the display-target user on the user terminal on the basis of the determined model of the object.

2. The system according to claim 1, wherein, when the display-target user is a personal-account user, the object of the display-target user is a character, and the control unit determines a model of the character corresponding to the distance score indicating the relationship from the display-target user to the user of the user terminal and performs control so as to display the character of the display-target user on the basis of the determined model of the character.

3. The system according to claim 1, wherein, when the display-target user is a non-personal-account user, the object of the display-target user is an environment, and the control unit determines a model of the environment corresponding to the distance score indicating the relationship from the display-target user to the user of the user terminal and performs control so as to display the environment of the display-target user on the basis of the determined model of the environment.

4. The system according to claim 1, further comprising an object model storage unit that stores, for each user, multiple stages of models of an object corresponding to distance scores indicating the relationships from the user to other users,
wherein the control unit selects, from among the models of the object stored in the object model storage unit, one model of the object of the display-target user on the basis of the distance score indicating the relationship from the display-target user to the user of the user terminal, the distance score being stored in the distance score storage unit, and performs control so as to display the object of the display-target user on the user terminal on the basis of the selected model of the object.

5. The system according to claim 4,
wherein the object model storage unit stores, for each personal-account user, multiple stages of models of a character corresponding to distance scores indicating the relationships from the user to other users, and
a model of the character corresponding to the smallest distance score is a model of the character for family or for best friends.

6. The system according to claim 1, further comprising a distance score calculation unit that calculates a distance score indicating the relationship from one user to another user,
wherein the distance score calculation unit calculates a distance score indicating the relationship from one user to another user on the basis of a weight for said another user set by said one user.

7. The system according to claim 6, wherein the distance score calculation unit calculates a distance score indicating the relationship from one user to another user, further on the basis of the number of links between nodes of said one user and said another user, the nodes indicating individual users in a social graph.

8. A method for displaying an object of a user in a virtual space, the method comprising:
a step of determining a model of an object of a display-target user on the basis of a distance score indicating the relationship from the display-target user to a user of a user terminal; and
a step of displaying the object of the display-target user on the user terminal on the basis of the determined model of the object.

9. The method according to claim 8, further comprising a step of calculating a distance score indicating the relationship from one user to another user,
wherein, in the step of determining, a model of an object of a display-target user is determined on the basis of a distance score indicating the relationship from the display-target user to the user of the user terminal, the distance score being calculated in the step of calculating.

10. A non-transitory computer readable medium storing a program causing one or more computers to execute the steps in the method according to claim 8.

11. A user terminal for displaying an object of a user in a virtual space, the user terminal comprising:
storing a model of an object of another user corresponding to a distance score indicating the relationship from said another user to a user of the user terminal; and
determining a model of an object of a display-target user on the basis of a distance score indicating the relationship from the display-target user to the user of the user terminal, the score being stored in a distance score storage unit, and displaying the object of the display-target user on the basis of the determined model of the object.

12. A server for displaying, on a user terminal, an object of a user in a virtual space, the server comprising:
storing a distance score indicating the relationship from one user to another user; and
determining a model of an object of a display-target user on the basis of a distance score indicating the relationship from the display-target user to a user of the user terminal, the distance score being stored in a distance score storage unit, and performing control so as to display the object of the display-target user on the user terminal on the basis of the determined model of the object.
